(19) United States
(12) Patent Application Publication
(10) Pub. No.: US 2003/0214960 A1
(43) Pub. Date: Nov. 20, 2003

(54) Packet redirection method for a network processor

(76) Inventors: Jong-Sang Oh, Suwon-shi (KR); Byung-Gu Choe, Seoul (KR); Young-Il Kim, Yongin-shi (KR)

Correspondence Address: CHA & REITER, 411 HACKENSACK AVE, 9TH FLOOR, HACKENSACK, NJ, 07601, US

(21) Appl. No.: 10/438,466

(22) Filed: May 16, 2003

(30) Foreign Application Priority Data
May 20, 2002 (KR) 2002-27856

(51) Int. Cl. H04L 12/28

(52) U.S. Cl. 370/401; 370/395.32

(57) ABSTRACT

The present invention discloses a packet redirection method for a function programmable network processor for processing packets based upon a user's requirements or intention. Th packet redirection method includes the steps of: defining a redirection port and a redirection ratio for a destination outgoing port which needs packet redirection among a plurality of outgoing ports upon the user's request, and storing the redirection port and the redirection ratio in a redirection memory area corresponding to the destination outgoing port of the network processor; detecting the destination outgoing port of the packet by performing a forwarding table lookup using a forwarding table, and queuing the packet to a queue of the destination outgoing port when the network processor receives the packet; determining a redirection setup state by accessing the redirection memory area corresponding to the destination outgoing port; and when a redirection is set, transmitting the packets to the destination outgoing port and the redirection port on the basis of the redirection port and the redirection ratio stored in the redirection memory area.

### CLAIM OF PRIORITY

This application claims priority to an application entitled “Packet redirection method for a network processor,” filed in the Korean Intellectual Property Office on May 30, 2002 and assigned Serial No. 2002-27856, the contents of which are hereby incorporated by reference.

### BACKGROUND OF THE INVENTION

1. Field of the Invention

The present invention relates generally to a network device and, in particular, to a packet redirection method for a network processor.

2. Description of the Related Art

Data bit rates as well as various types of support services have been increased due to the occurrence of new internet services, for example, integrated voice and data, and integrated wire/wireless internet. However, existing application specific integrated circuit (ASIC)-based network device, which composes an internet network and is based on a silicon chip, fails to have a new function or improved performance. In addition, it has a limited packet processing capacity due to environmental variations. In particular, such a network device is generally developed with an ASIC switch chip. Thus, the network device only uses the functions provided by the ASIC switch chip. In order to use such functions, the network device must set up register values provided by the ASIC switch chip. It is thus impossible to modify the existing functionality or add new functionality.

Accordingly, a new network device based on a network processor has been suggested (e.g., a next generation silicon chip). The network processor is a programmable processor for processing a packet from an input user interface (input port) in various methods before transmitting it to an output user interface (output port). In addition, it is a specialized packet processing processor for providing an ASIC-level high performance packet processing capacity and promptly responding to various demands of network users through a program. That is, the network processor is a non-memory semiconductor for (1) providing a variety of multimedia internet traffic services by using a programming function, (2) inter-port traffic transmission and (3) intelligent switching in the network device such as a router and a switch. Therefore, it may be deemed as a core component of the next generation network device.

One representative example of the network processor, which is the next generation silicon chip, is the IXP1200 of Intel Corporation. The network processor, such as the IXP1200, enables users to perform program coding by introducing an instruction cache memory. That is, the network processor can be configured according to a particular use needed by an application that the network processor is applied. The program of the IXP1200 of Intel Corporation is called a micro-code. The micro-code is an assembly language executed in the IXP1200. In order to execute the micro-code, when the embodied code is downloaded to the instruction cache memory, the respective processor engines of the network processor receive instructions from the instruction cache memory and executes them. The network processor may include a plurality of a of the processor engines, for example, six. The number is determined upon the user's intention so that the micro-codes of each processor engine can be embodied according to a particular use or uses.

FIG. 1 is a block diagram illustrating an IXP1200 network processor 50 for processing a packet. The IXP1200 network processor 50 includes a packet-receiving unit 2, a packet forwarding unit 4 and a packet-transmitting unit 6. The packet receiving unit 2, the packet forwarding unit 4 and the packet-transmitting unit 6 include processor engines embodied by micro-codes. The packet-receiving unit 2 has a receiving engine 8, the packet-forwarding unit 4 has a forwarding engine 12, and the packet-transmitting unit 6 has a transmitting engine 18. The packet receiving unit 2 confirms reception of the packet from the corresponding input port and transmits the input packet to a packet buffer for storing packets, namely an input queue 10. The packet forwarding unit 4 reads necessary information from the header of the packet stored in the input queue 10, performs a forwarding table lookup by using the information from the header of the packet and an internal forwarding table 14 and detects a destination outgoing port. Thereafter, the packet-forwarding unit 4 queues the packet to an outgoing port queue corresponding to the destination outgoing port among the outgoing port queues 16. The packet transmitting unit 6 periodically confirms whether the packet is queued to the outgoing port queue corresponding to each destination, and transmits the queued packet to the corresponding outgoing port.

As described above, the packet transmitting unit of the micro-code embodied in the IXP-1200 network processor is designed to transmit the packet only to the destination outgoing port obtained by the forwarding table lookup of the packet forwarding unit. Accordingly, it is normal to transmit the packet to the corresponding destination outgoing port. However, when the destination outgoing port is previously set orif the packet needs to be transmitted to a different port, a new method is required. For example, when packet need to be redirected to a different port for duplexing due to an error of the destination outgoing port, port snooping for monitoring the network device, or port trunking for operating a plurality of ports as one port. Attempts have been made to provide ASIC-based network devices a redirection function. However, as explained above, the ASIC-based network device cannot modify the existing functionality or be used for other purposes. That is, the general ASIC-based network device has only a predetermined redirection function. Thus, there is a need for an effective means to embody a redirection function for selectively changing the outgoing ports according to various cases and application requirements.

### SUMMARY OF THE INVENTION

A packet redirection method is achieved that reduces or overcomes the above limitations by providing a packet redirection method for a function programmable network processor for processing packets upon a user's intention or predefined/real-time requests. Moreover, the packet redirection method enables transmission of a packet to a redirection port as well as a destination outgoing port in a function programmable network device for processing packets upon the user's intention. Still further, the present invention provides a packet redirection method for a function programmable network processor for processing packets upon the user's intention, which can selectively change an outgoing port in a network device.

In accordance with principals of the present invention, a packet redirection method is provided for a function programmable network processor for processing packets upon a user requirements or intention. The packet redirection method includes the steps of: defining a redirection port and a redirection ratio for the destination outgoing port which needs packet redirection among a plurality of outgoing ports upon the user's request, and storing the redirection port and the redirection ratio in a redirection memory area corresponding to a destination outgoing port of the network processor; detecting the destination outgoing port of the packet by performing a forwarding table lookup using a forwarding table and queuing the packet to a queue of the destination outgoing port, when the network processor receives the packet; determining whether a redirection is set up by accessing the redirection memory area corresponding to the destination outgoing port; and if so, transmitting the packets to the destination outgoing port and the redirection port on the basis of the redirection port and the redirection ratio stored in the redirection memory area.

According to one aspect of the invention, the function of transmitting the packet to the redirection port, instead of the destination outgoing port to which the packet is supposed to be transmitted is defined as “packet redirection”. As further explained below, the destination outgoing port of the invention is a port which is detected by the forwarding table lookup of the packet forwarding unit of the network processor, and which transmission of the packet is intended The redirection port is not the destination outgoing port detected by the forwarding table lookup, but a port, which the packet is transmitted (e.g. redirected) to for other purposes.

### BRIEF DESCRIPTION OF THE DRAWINGS

The present invention will become more apparent from the following detailed description when taken in conjunction with the accompanying drawings in which:

FIG. 1 is a block diagram illustrating an IXP1200 network processor for processing a packet;

FIG. 2 is a block diagram illustrating an IXP1200 network processor for processing a packet in outgoing port redirection in accordance with a preferred embodiment of the present invention;

FIG. 3 is a flowchart showing a packet processing procedure of the IXP1200 network processor in the outgoing port redirection in accordance with the preferred embodiment of the present invention;

FIG. 4 is a diagram illustrating a memory map for defining a redirection port and a redirection ratio for destination outgoing ports requiring packet redirection in accordance with the preferred embodiment of the present invention;

FIG. 5 is a table showing a test result of applications to a network device; and

FIG. 6 is a diagram illustrating an application example using the redirection method in accordance with the preferred embodiment of the present invention.

### DETAILED DESCRIPTION OF THE PREFERRED EMBODIMENT

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

One aspect of the operation of the present invention is to enable transmission of a packet to a redirection port, when redirection is set, for example, in response to user requirements or intentions. The redirection is set up in a destination outgoing port detected through a forwarding table lookup of a processing unit of an IXP1200 network processor. At this time, whether the whole packets are redirected, or whether a predetermined ratio of packets are redirected and the remaining packets are transmitted to the actual destination outgoing port must be determined in advance. The corresponding information is stored in a memory of the network processor. As noted above, the network processor is function-programmed to redirect a different ratio of packets to various ports upon the user's intention.

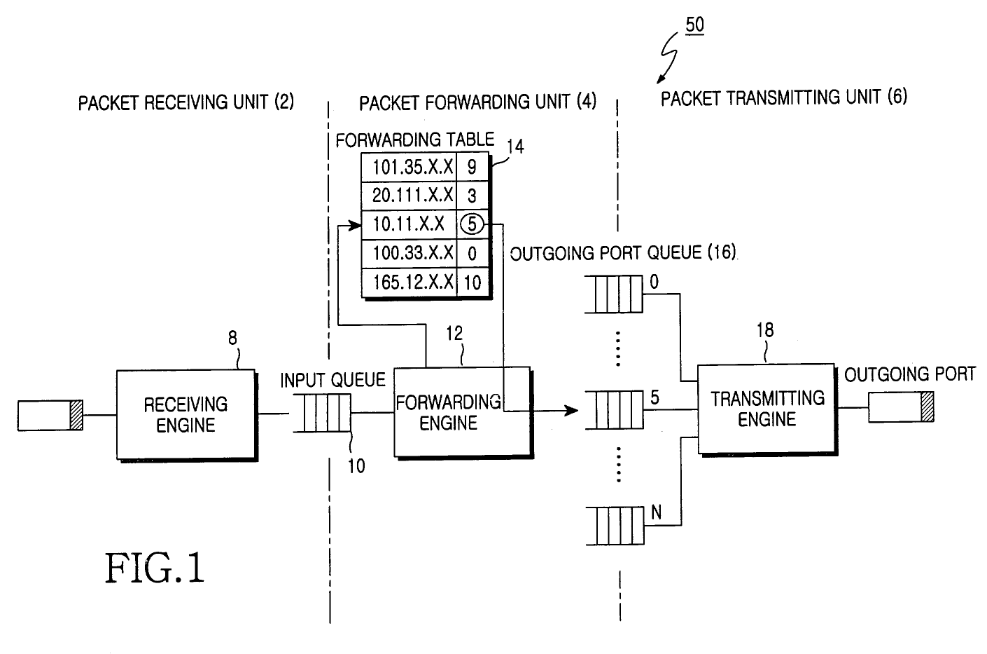

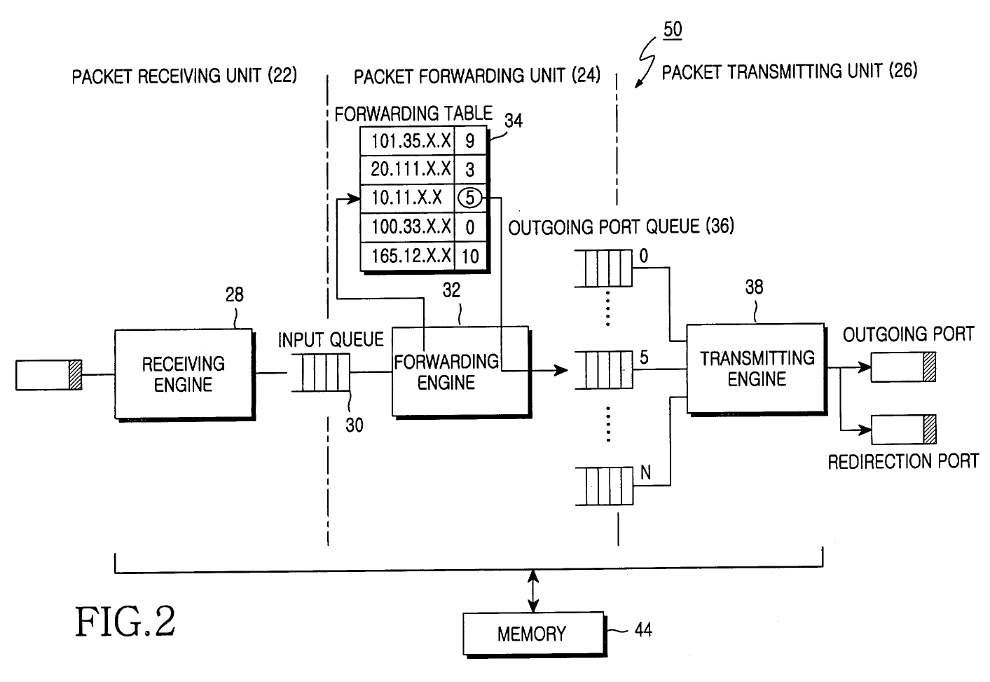

FIG. 2 is a block diagram illustrating the IXP1200 network processor 50 for processing the packet in the outgoing port redirection in accordance with the preferred embodiment of the present invention, which is similar to FIG. 1. As illustrated in FIG. 2, the IXP1200 network processor 50 includes a packet-receiving unit 22, a packet forwarding unit 24 and a packet-transmitting unit 26. The packet receiving unit 22, the packet forwarding unit 24 and the packet-transmitting unit 26 include processor engines embodied by micro-codes. The packet-receiving unit 22 has a receiving engine 28, the packet-forwarding unit 24 has a forwarding engine 32 and the packet-transmitting unit 16 has a transmitting engine 38. In further reference to FIG. 2, a forwarding table 34 is formed in an external memory.

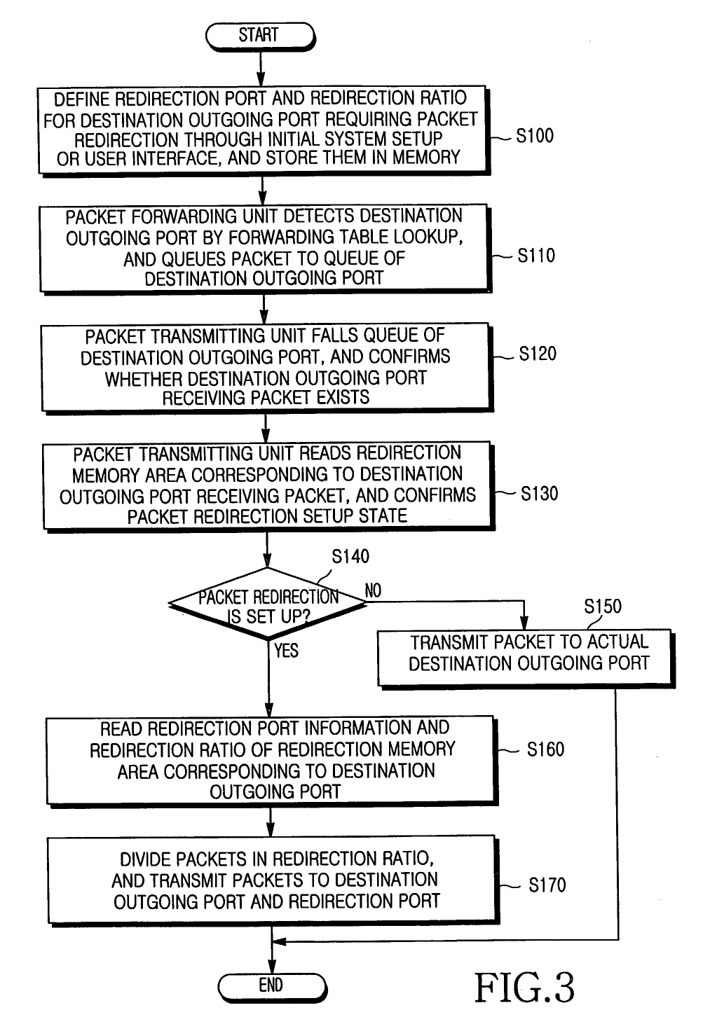

FIG. 3 is a flowchart showing a packet processing procedure of the IXP1200 network processor 50 in the outgoing port redirection in accordance with the preferred embodiment of the present invention.

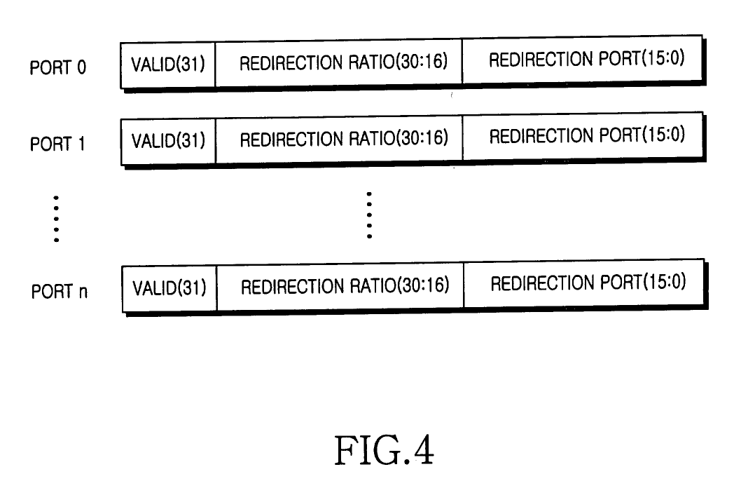

FIG. 4 is a structure diagram illustrating a memory map for defining a redirection port and a redirection ratio for the destination outgoing ports requiring packet redirection in accordance with the preferred embodiment of the present invention.

Referring now to FIGS. 2, 3 and 4, the packet redirection operation of the packet transmitting unit 26 will be explained in detail.

1) In the embodiment of the present invention, the redirection port and the redirection ratio for the destination outgoing port requiring packet redirection are defined through the initial system setup or user interface, and stored in the memory 44 of the network processor 50 in a format shown in FIG. 4. For example, the redirection port and the redirection ratio are defined and stored in a scratch pad memory of the IXP1200 network processor (S100 of FIG. 3).

Referring to FIG. 4, the respective destination outgoing ports receive a 32-bit memory area (abbreviated as ‘redirection memory area’). In the 32-bit redirection memory area for each destination outgoing port, a 15:0 bit area is used to store redirection port information, and a 30:16 bit area is used to store the redirection ratio. In addition, bit 31 is used as a valid bit notifying the redirection setup state. Preferably, the redirection ratio is represented as integers, from 1 to 100. Here, ‘redirection ratio’=redirection frame number/total frame number*100′ is satisfied.

2) On the other hand, the packet receiving unit 22 confirms reception of the packet from the corresponding input port, stores the received packet in a packet buffer for storing packets, and transmits the packet information to an input queue 30. The packet forwarding unit 24 reads the information stored in the input queue 30 and detects a destination outgoing port according to a forwarding table lookup using the read information and the forwarding table 34 stored in an external memory. Thereafter, the packet forwarding unit 24 queues the packet to the queue of the destination outgoing port among the outgoing port queues 16 (S110 of FIG. 3). The example of FIG. 2 queues the packet to the queue of the fifth destination outgoing port according to the forwarding table lookup of the forwarding engine 32.

3) The packet transmitting unit 28 of the network processor 50 fills the respective outgoing port queues 36, and determines whether any of the destination outgoing ports receives the packet (S120 of FIG. 3).

4) When the destination outgoing port receiving the packet exists, the packet transmitting unit 26 accesses the memory 44 of FIG. 4, and reads information from the redirection memory area corresponding to the destination outgoing port (S130 of FIG. 3). After reading the information from the redirection memory area corresponding to the destination outgoing port, the packet transmitting unit 26 judges whether the value of bit 31 is ‘1’ (S140 of FIG. 3). The packet redirection has been set up when the value of bit 31 is ‘1’, and is not set up when the value of bit 31 is ‘0’.

5) When the value of bit 31 is ‘0’ in S140 of FIG. 3, namely when the packet redirection is not set up, the packet transmitting unit 38 transmits the packet to the actual destination outgoing port (S150 of FIG. 3).

6) When the value of bit 31 is ‘1’ in S140 of FIG. 3, namely when the packet redirection has been set up, the packet transmitting unit 38 reads 15:0 bit redirection port information and 16:30 bit redirection ratio from the redirection memory area corresponding to the destination outgoing port (S160 of FIG. 3). Thereafter, the packet-transmitting unit 38 transmits the packets to the destination outgoing port and the redirection port according to the redirection ratio read from the memory 44 (S170 of FIG. 3).

The process for transmitting the packets to the destination outgoing port and the redirection port according to the redirection ratio can be performed as a following pseudo code:

| n=0; | // initial setup of packet count |
|---|---|
| while (1) { | |
| ... | // existing code executing unit |

if (N-n >= 0) { // N is redirection ratio

send to r_p; // r_p is redirection port
n = n+1;

}
else {

send to d_o_p; // d_o_p is destination outgoing port
n = n+1;

}
if((n-100)= 0)

n = 0;

| | |
|---|---|
| ... | // existing code executing unit |

}

As shown above, each of the network processors can selectively designate ‘send to port’, namely send to r_p and send to d_o_p of the pseudo code. For example, the IXP1200 network processor must designate an outgoing port to its control field register under the instruction tfifo_wr in order to transmit the respective packets. Thus, in one illustrative example, the IXP1200 network processor designates an outgoing port designation portion of the control field register as a redirection port under the instruction tfifo_wr so as to perform the packet redirection.

The notable characteristic of the present invention is to program the network processor to redirect a different ratio of packets to various ports upon the user's intention or requirements. One example of the process for transmitting the packets according to the redirection ratio transmits the packets to the redirection port before the destination outgoing port and then transmits the remaining packet to the destination outgoing port. However, if necessary, it is also possible to transmit the packets to the destination outgoing port and then transmit the residual packets to the redirection port.

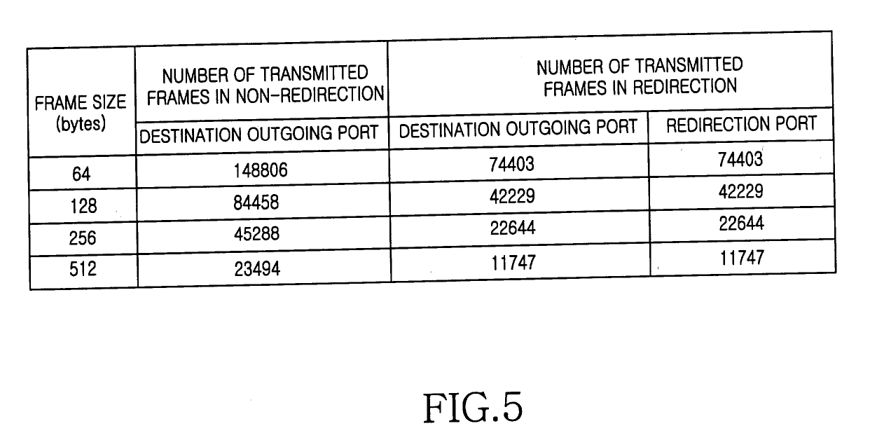

FIG. 5 is a table showing a test results of the network device when it uses or doesn't use the packet redirection method and when the packet is transmitted thereto. In the test, the redirection is performed at a ratio of 50:50. That is, the redirection ratio is 50% (1/2). As shown in the test results of FIG. 5, when the redirection is not used, all the packets are transmitted to the destination outgoing port, and when the packet redirection of 50:50 is used, 50% of packets are transmitted to the destination outgoing port and 50% of packets are transmitted to the redirection port. That is, the destination outgoing port and the redirection port share 50% of load, respectively.

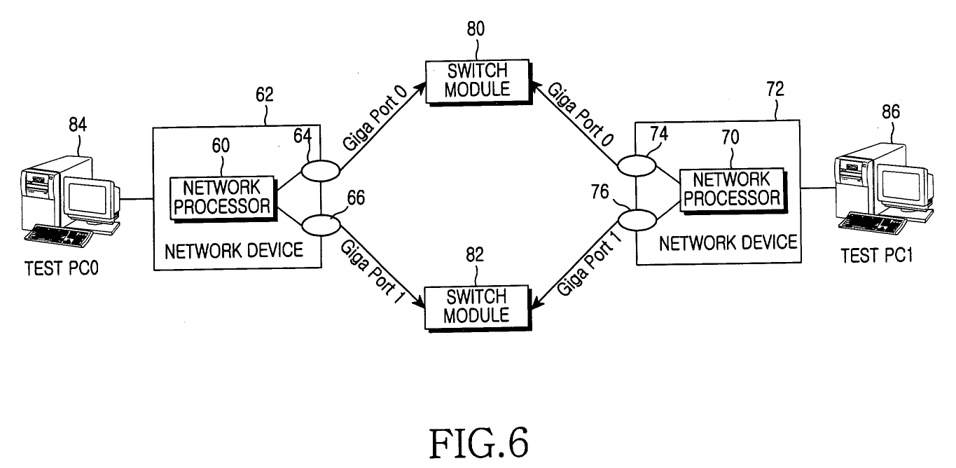

FIG. 6 is a diagram illustrating an application example where the network device uses the packet redirection method in accordance with the preferred embodiment of the present invention. Referring to FIG. 6, network devices 62 and 72 on which network processors 60 and 70 are mounted have two giga bit ports 64, 66, 74 and 76 positioned toward switch modules 80 and 82. In order to provide the duplexing function, the two giga bit ports 64, 66, 74 and 76 are connected to different switch modules, namely switch module 80 and switch module 82. In FIG. 6, the two outgoing ports 64, 66, 74 and 76 are operated as one outgoing port. Even if one of the outgoing ports has failure, the packet is transmitted to the other outgoing port, thereby providing the duplexing function to the network device.

In this embodiment, it is possible to program the network processor to perform the packet redirection upon the user's intention or requirement, such as the duplexing function shown in FIG. 6. For example, the packet redirection for port snooping for monitoring the network device, and the packet redirection for port trunking for operating a plurality of ports as one port can be adaptively selected. That is, the redirection function is provided to selectively change the outgoing port in various cases.

In accordance with the present invention, the packet redirection method applied to the transmitting unit of the network processor not only extends the existing function of the network processor, but also enables re-configuration of existing functions as well as new functions.

As discussed earlier, in accordance with the present invention, a different ratio of packets are redirected to various ports to embody the whole functions requiring the redirection in the network device using the network processor, such as the duplexing function, the port snooping function for monitoring a different network port, or the port trunking function for operating a plurality of ports as one port.

While the invention has been shown and described with reference to a certain preferred embodiment thereof, various changes in form and details may be made therein without departing from the spirit and scope of the invention as defined by the appended claims. That is, the present invention can be applied to a micro-code (assembly language executed in IXP1200) program development field for processing packets in the network processor. Especially, even though the present invention is embodied in the IXP1200 of Intel Corporation which is one of the commonly used network processors, it will be understood by those skilled in the art that various changes in form and details may be made in all the network processors. In particular, the functions of the various elements shown in the Figures, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context. As a result, the scope of the invention should not be determined by the above-described embodiment, but the claims and equivalents thereof.

What is claimed is:

1. A packet redirection method for a network processor having a plurality of outgoing ports, the method comprising the steps of:
defining, for a destination outgoing port of the plurality of outgoing ports, a redirection port and a redirection ratio using a user's request;
storing the redirection port and the redirection ratio in a redirection memory;
detecting the destination outgoing port of a received packet;
determining a redirection setup state by accessing the redirection memory; and
if the redirection state is set, transmitting the packets to the destination outgoing port and the redirection port using the redirection port and the redirection ratio stored in the redirection memory.

2. The method as claimed in claim 1, wherein the detecting step further includes detecting the destination outgoing port of the received packet by performing a forwarding table lookup using a forwarding table and queuing the packet to a queue of the destination outgoing port.

3. The method as claimed in claim 1, wherein the redirection memory corresponds to the destination outgoing port and comprises a valid bit area for showing the redirection setup state, a bit area for storing the redirection port information and a bit area for storing the redirection ratio.

4. The method as claimed in claim 1, wherein the user's request is achieved through at least one a system initialization and a user interface.

5. A selective packet redirection method for a network processor having a plurality of outgoing ports, the method comprising the steps of:
for a received user request, defining a redirection port and a redirection ratio for an outgoing port;
for the outgoing port, selectively transmitting received packets to the outgoing port and redirection port using the defined redirection port and a redirection ratio.

6. The method as claimed in claim 5, further including the step of detecting the outgoing port of the received packet by performing a forwarding table lookup using a forwarding table and queuing the packet to a queue of the destination outgoing port.

7. The method as claimed in claim 5, further including the step of storing the redirection port and the redirection ratio in a redirection memory, wherein the redirection memory corresponds to the outgoing port and comprises a valid bit area for showing the redirection setup state, a bit area for storing the redirection port information and a bit area for storing the redirection ratio.

8. The method as claimed in claim 5, wherein the user request is achieved through at least one a system initialization and a user interface.

9. A network device comprising:
a plurality of outgoing ports;
a processor configured to (1) receive a user request to define, for an outgoing port, a redirection port and a redirection ratio, and (2) for the outgoing port, transmitting received packets the outgoing port and redirection port using the defined redirection port and a redirection ratio.

10. The network device as claimed in claim 9, wherein the user request is achieved through at least one a system initialization and a user interface.
